(19) United States
(12) Patent Application Publication
(10) Pub. No.: US 2026/0106866 A1
(43) Pub. Date: Apr. 16, 2026

(54) Method and Apparatus for Internet Protocol Security Authentication

(71) Applicant: Telefonaktiebolaget LM Ericsson (publ), Stockholm (SE)

(72) Inventor: Renwang Liu, Beijing (CN)

(21) Appl. No.: 19/114,146

(22) PCT Filed: Sep. 21, 2022
(86) PCT No.: PCT/CN2022/120232

§ 371 Date: Mar. 21, 2025

(51) Int. Cl. H04L 9/40

(52) U.S. Cl. CPC H04L 63/083; H04L 63/061

(57) ABSTRACT

Embodiments of the present disclosure provide a method and an apparatus for internet protocol security authentication. A method (100) performed by a first communication device comprises: connecting (S102) to a network node; receiving (S104) a token from the network node; and using (S106) the token for internet key exchange, IKE. According to embodiments of the present disclosure, by using a network node as a centralized authentication platform, which is able to generate and manage tokens and distribute them to authorized communication device, communication device can use the dynamically generated key to authenticate the IKE messages.

### TECHNICAL FIELD

The present disclosure relates generally to the technology of communication network, and in particular, to a method and an apparatus for internet protocol security authentication.

### BACKGROUND

This section introduces aspects that may facilitate better understanding of the present disclosure. Accordingly, the statements of this section are to be read in this light and are not to be understood as admissions about what is in the prior art or what is not in the prior art.

In a communication system, many technologies are used to improve the security of communication between different devices.

For example, an Internet Protocol Security, IPsec, is widely used in communication networks. IPsec consists of the following protocols: authentication header (AH), which provides connectionless data integrity, message authentication and protection against replay attacks for IP datagrams; Encapsulate security payload (ESP), providing confidentiality, data source authentication, connectionless integrity, anti-replay and limited traffic-flow confidentiality; Security association (SA): provides algorithms, packets, and parameters required by AH and ESP operations; and Internet Key Exchange (IKE) provides the survival and exchange of keys with symmetric ciphers.

During IKE authentication progress, a pre-shared key authentication method with simple configuration may be adopted. However, the pre-shared key might be not strong enough in terms of network security.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

For example, during IKE authentication progress, the pre-shared key might be simple (i.e., relatively short and/or including commonly used numbers or words) and easy to be stolen during negotiation via the network. Generally, the way for operator to share keys is relatively simple and inflexible. Further, the keys will not be easily shared by operators in different organizations or with different authorities.

Certain aspects of the present disclosure and their embodiments may provide solutions to these or other challenges. There are, proposed herein, various embodiments which address one or more of the issues disclosed herein.

A first aspect of the present disclosure provides a method performed by a first communication device. The method comprises: connecting to a network node; receiving a token from the network node; and using the token for internet key exchange, IKE.

In embodiments of the present disclosure, the token may be used as a pre-shared key, PSK, for the IKE; or the PSK may be calculated based on the token.

In embodiments of the present disclosure, the token may comprise numeric password.

In embodiments of the present disclosure, the token may be encrypted.

In embodiments of the present disclosure, the token may be received by the first communication device via a security tunnel.

In embodiments of the present disclosure, the token may be configured with an expiration period.

In embodiments of the present disclosure, the token may be generated by the network node, based at least on an identifier of the first communication device.

In embodiments of the present disclosure, the identifier may comprise a dial-in number, or a user name with password.

In embodiments of the present disclosure, the IKE may be between the first communication device and a second communication device.

In embodiments of the present disclosure, the method may further comprise: transmitting the token to a third communication device. The IKE may be between the third communication device and a second communication device.

In embodiments of the present disclosure, the first communication device may comprise a user equipment, UE; and/or the network node may comprise a soft token manager.

A second aspect of the present disclosure provides a method performed by a network node. The method comprises: connecting to a first communication device; and transmitting a token to the first communication device. The first communication device uses the token for internet key exchange, IKE.

In embodiments of the present disclosure, the token may be used as a pre-shared key, PSK, for the IKE; or the PSK may be calculated based on the token.

In embodiments of the present disclosure, the token may comprise numeric password.

In embodiments of the present disclosure, the token may be encrypted.

In embodiments of the present disclosure, the token may be transmitted by the network node via a security tunnel.

In embodiments of the present disclosure, the token may be configured with an expiration period.

In embodiments of the present disclosure, the method may further comprise: generating the token, based at least on an identifier of the first communication device.

In embodiments of the present disclosure, the identifier may comprise a dial-in number, or a user name with password.

In embodiments of the present disclosure, the IKE may be between the first communication device and a second communication device.

In embodiments of the present disclosure, the first communication device may transmit the token to a third communication device; and the IKE may be between the third communication device and a second communication device.

In embodiments of the present disclosure, the first communication device comprises a user equipment, UE; and/or the network node comprises a soft token manager.

A third aspect of the present disclosure provides an apparatus for a first communication device. The apparatus for the first communication device comprises: a processor; a memory, the memory containing instructions executable by the processor. The apparatus for the first communication device is operative for: connecting to a network node; receiving a token from the network node; and using the token for internet key exchange, IKE.

In embodiments of the present disclosure, the apparatus may be further operative to perform the method according to any of above embodiments.

A fourth aspect of the present disclosure provides an apparatus for a network node. The apparatus for the network node comprises: a processor; a memory, the memory containing instructions executable by the processor. The apparatus for the network node is operative for: connecting to a first communication device; and transmitting a token to the first communication device. The first communication device uses the token for internet key exchange, IKE.

A fifth aspect of the present disclosure provides computer-readable storage medium storing instructions, which when executed by at least one processor, causes the at least one processor to perform the method according to any of above embodiments.

Embodiments herein afford many advantages. According to embodiments of the present disclosure, improved methods and improved apparatuses for internet protocol security authentication are provided.

By using a network node as a centralized authentication platform, which is able to generate and manage tokens and distribute them to authorized communication device, communication device can use the dynamically generated key to authenticate the IKE messages.

### BRIEF DESCRIPTION OF DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1A is an exemplary flow chart for a method performed by a first communication device, according to exemplary embodiments of the present disclosure.

FIG. 1B is an exemplary flow chart showing additional steps of the method showing in FIG. 1A, according to exemplary embodiments of the present disclosure.

FIG. 2A is an exemplary flow chart for a method performed by a network node, according to exemplary embodiments of the present disclosure.

FIG. 2B is an exemplary flow chart showing additional steps of the method showing in FIG. 2A, according to exemplary embodiments of the present disclosure.

FIG. 3A is a general IPsec architecture diagram.

FIG. 3B is an exemplary diagram showing a procedure of IKEv2.

FIG. 4A is a first exemplary diagram showing an embedded plugin in IKE protocol to automatically generate the IKE soft token keys to be used in IKE authentication exchange, according to embodiments of the present disclosure.

FIG. 4B is a second exemplary diagram showing an embedded plugin in IKE protocol to automatically generate the IKE soft token keys to be used in IKE authentication exchange, according to embodiments of the present disclosure.

FIG. 4C is a third exemplary diagram showing an embedded plugin in IKE protocol to automatically generate the IKE soft token keys to be used in IKE authentication exchange, according to embodiments of the present disclosure.

FIG. 5 is a diagram showing an exemplary system architecture of a Soft Token Manager.

FIG. 6 is a flow chart showing a workflow for the key generation procedure.

FIG. 7A is a block diagram showing an exemplary apparatus for a first communication device, which is suitable for performing the method according to embodiments of the disclosure.

FIG. 7B is a block diagram showing an exemplary apparatus for a network node, which is suitable for performing the method according to embodiments of the disclosure.

FIG. 8 is a block diagram showing an apparatus/computer readable storage medium, according to embodiments of the present disclosure.

FIG. 9A is a block diagram showing modules for a first communication device, which are suitable for performing the method according to embodiments of the disclosure.

FIG. 9B is a block diagram showing modules for a network node, which are suitable for performing the method according to embodiments of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

As used herein, the term “network” or “communication network” refers to a network following any suitable communication standards (such as an internet network, or any wireless network). For example, wireless communication standards may comprise new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. In the following description, the terms “network” and “system” can be used interchangeably. Furthermore, the communications between two devices in the network may be performed according to any suitable communication protocols, including, but not limited to, the wireless communication protocols as defined by a standard organization such as 3rd generation partnership project (3GPP) or the wired communication protocols.

The term “network node” used herein refers to a network device or network entity or network function or any other devices (physical or virtual) in a communication network. For example, the network node in the network may include a base station (BS), an access point (AP), a multi-cell/multicast coordination entity (MCE), a server node/function (such as a service capability server/application server, SCS/AS, group communication service application server, GCS AS, application function, AF), an exposure node/function (such as a service capability exposure function, SCEF, network exposure function, NEF), a unified data management, UDM, a home subscriber server, HSS, a session management function, SMF, an access and mobility management function, AMF, a mobility management entity, MME, a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node may comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like.

Further, the term “network node”, “network function”, “network entity” herein may also refer to any suitable node, function, entity which can be implemented (physically or virtually) in a communication network. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), etc. In other embodiments, the network function may comprise different types of NFs (such as PCRF (Policy and Charging Rules Function), etc.) for example depending on the specific network.

The term “terminal device/communication device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP, such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IOT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and (or) B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

In communication systems, IP Security (IPsec) provides confidentiality, data integrity, access control, and data source authentication to IP datagrams. These services are provided by maintaining shared state between the source and the sink of an IP datagram. This state defines, among other things, the specific services provided to the datagram, cryptographic algorithms which will be used to provide the services, and the keys used as input to the cryptographic algorithms. The IPsec protocol suite is widely used for business-critical network traffic.

The reason that the IPsec application can securely communicate on the public network is mainly because various security mechanisms are available to ensure the entire tunnel establishment and data transmission process between peers. IKE contributes much on the security key exchange and generation. Because IKE has a set of self-protection mechanisms, it can authenticate identities and distribute keys on insecure networks.

For IKE authentication mechanism, when IKE is used to exchange information between peers, the validity of the peer must be identified first, that is authentication. In IKE, a comprehensive mechanism can be used to determine the peer identity (IP address or name of the peer), including pre-shared key (PSK) authentication, RSA (Rivest, Shamir, Adleman) digital certificate (RSA-signature) authentication, and RSA digital envelope authentication.

For the IKE pre-shared key authentication, the shared key will be one of key generation material, which can be used by the two communication parties with the same hash algorithm which were carried out on the packet hash algorithm. According to whether the result of calculation is consistent with the hash from the sender, the receiver judges whether the received data been tampered with, and whether the source is reliable. If they are the same, the authentication succeeds. Otherwise, the authentication fails.

In most IPsec applications, the pre-shared key authentication method with simple configuration is adopted. However, it also has some natural disadvantages.

For example, the key is simple and easy to be stolen during negotiation. The way of operator sharing key is relatively simple and inflexible. Not easily shared by operators in different organizations or with different authorities.

For the digital certificate authentication, the communication parties use CA (Certification Authority) certificates to verify the validity of digital certificates. In the CA certificate, each party has its own public key (transmitted over the network) and private key (held by itself). The sender hashes the original packet and encrypts the calculated result with its own private key to generate a digital signature. The receiver uses the sender's public key to decrypt the digital signature, and then hashes the decrypted packet using the same hash algorithm to check whether the result is the same as the hash value sent by the decrypted sender. If they are the same, the authentication succeeds. Otherwise, the authentication fails.

For safety, this is preferred way since it's obviously much safer. However, to use certificate as the authentication way in IPsec is not economic. Because certificates should be enrolled by PKI system. The first step is to establish or follow a third-party authority to build the CA, and secondly it needs to enroll the user information offline or online (CMPv2 (Certificate Management Protocol version 2) protocol) with the CA system, then download the certificate and install it into node. This authentication way is lacking economic and mobility.

According to embodiments of the present disclosure, an improved authentication mode between pre-shared key and certificate authentication is provided to ensure high efficiency, high security, and meanwhile enhanced scalability and mobility.

With the help of the currently popular soft token technology, this can be achieved. This is highly recommended and obvious advantage in mobile terminal (e.g., 5G UE) devices.

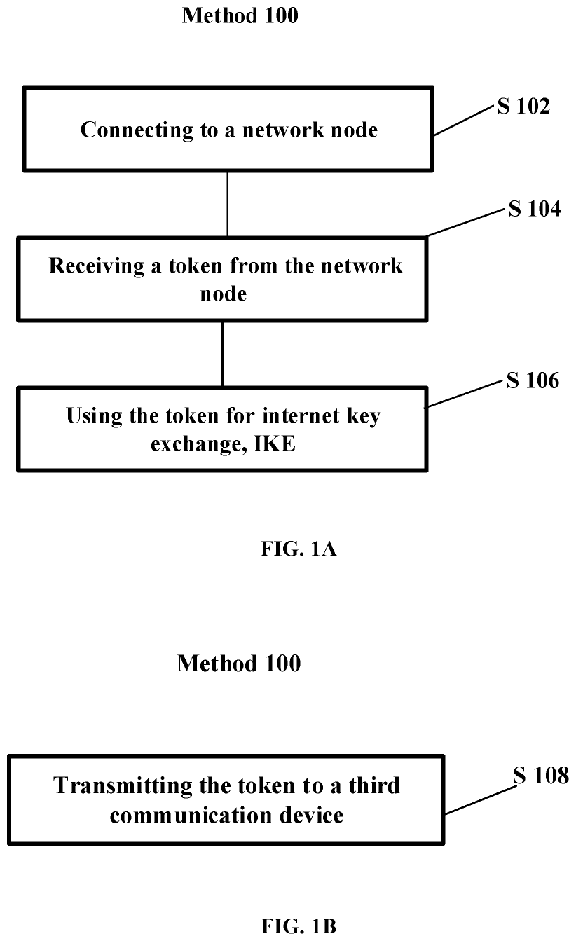

FIG. 1A is an exemplary flow chart for a method performed by a first communication device, according to exemplary embodiments of the present disclosure.

As shown in FIG. 1A, the method 100 comprises: a step S102, connecting to a network node; a step S104, receiving a token from the network node; and a step S106, using the token for internet key exchange, IKE.

According to embodiments of the present disclosure, by using a network node as a centralized authentication platform, which is able to generate and manage tokens and distribute them to authorized communication device, communication device can use the dynamically generated key to authenticate the IKE messages.

In embodiments of the present disclosure, the token may be used as a pre-shared key, PSK, for the IKE; or the PSK may be calculated based on the token.

In embodiments of the present disclosure, the token may comprise numeric password.

In embodiments of the present disclosure, the token may be encrypted.

In embodiments of the present disclosure, the token may be received by the first communication device via a security tunnel.

In embodiments of the present disclosure, the token may be configured with an expiration period.

In embodiments of the present disclosure, the token may be generated by the network node, based at least on an identifier of the first communication device.

In embodiments of the present disclosure, the identifier may comprise a dial-in number, or a user name with password.

In embodiments of the present disclosure, the IKE may be between the first communication device and a second communication device.

FIG. 1B is an exemplary flow chart showing additional steps of the method showing in FIG. 1A, according to exemplary embodiments of the present disclosure.

In embodiments of the present disclosure, the method may further comprise: a step S108, transmitting the token to a third communication device. The IKE may be between the third communication device and a second communication device.

In embodiments of the present disclosure, the first communication device may comprise a user equipment, UE; and/or the network node may comprise a soft token manager.

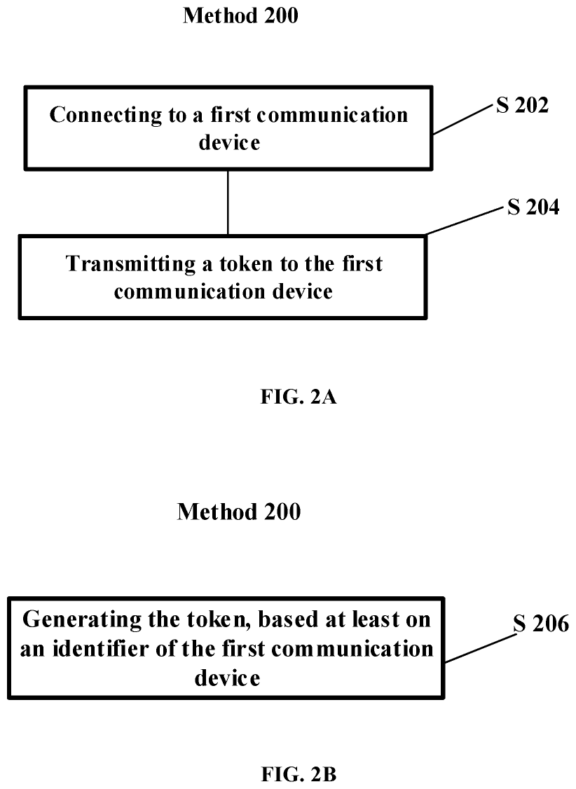

FIG. 2A is an exemplary flow chart for a method performed by a network node, according to exemplary embodiments of the present disclosure.

As shown in FIG. 2A, the method 200 comprises: a step S202, connecting to a first communication device; and a step S204, transmitting a token to the first communication device. The first communication device uses the token for internet key exchange, IKE.

In embodiments of the present disclosure, the token may be used as a pre-shared key, PSK, for the IKE; or the PSK may be calculated based on the token.

In embodiments of the present disclosure, the token may comprise numeric password.

In embodiments of the present disclosure, the token may be encrypted.

In embodiments of the present disclosure, the token may be transmitted by the network node via a security tunnel.

In embodiments of the present disclosure, the token may be configured with an expiration period.

FIG. 2B is an exemplary flow chart showing additional steps of the method showing in FIG. 2A, according to exemplary embodiments of the present disclosure.

In embodiments of the present disclosure, the method may further comprise: a step S206, generating the token, based at least on an identifier of the first communication device.

In embodiments of the present disclosure, the identifier may comprise a dial-in number, or a user name with password.

In embodiments of the present disclosure, the IKE may be between the first communication device and a second communication device.

In embodiments of the present disclosure, the first communication device may transmit the token to a third communication device; and the IKE may be between the third communication device and a second communication device.

In embodiments of the present disclosure, the first communication device comprises a user equipment, UE; and/or the network node comprises a soft token manager.

According to embodiments of the present disclosure, it's a new authentication way on IPsec/IKE protocol.

By building a centralized authentication platform, which is able to generate and manage tokens and distribute them to authorized users, then users can use the dynamically generated key to authenticate the IKE messages.

Depending on the user management mechanism, via the centralized authentication platform, administrator can control the token validity period, refresh mechanism, and revocation at the same time.

It's new authentication way to replace and enhance the traditional pre-shared key in IKE exchange. A user and token management program can be integrated with the original IPsec application.

It could be a separate system. For example, a user handheld a UE with a SIM card inserted and the corresponding applications installed. The user could generate the IKE ‘dynamic KEY’ via APP in the phone and input this key in the IPsec devices.

Or it could just be the UE itself, when he wants to establish an IPsec tunnel, he can use the IPsec application to generate the ‘dynamic KEY’ by itself internally, in that case the soft token could be programed in the IPsec application.

The new authentication method will have following advantages.

Significantly improved mobility is its biggest advantage, with the new method it can auto-generate the IKE authentication key based on the soft-token. The method can be used on the UE devices and there will be no need to re-negotiate the pre-shared key based on different network scenarios and topology.

Flexibility can also be greatly improved. For devices equipped in lab room, dynamic passwords can be obtained through operators' mobile phones; for UE devices itself, tokens can be generated through integrated functions.

Manually negotiated password is not easy to be managed and shared, but automatic generation of secret keys has high timeliness and efficiency.

There will be no need to deploy a bit-scale PKI environment and it will be economic.

It's a user based soft-token management system. Admin can set different group permissions and token generation mechanisms for different users.

Passwords or tokens are dynamically generated and changed, it's hard for attacker to intercept and tamper with, and it will be safer.

It's a relatively open and compatible method, which can be implemented by different vendors, products, and platforms.

Some detailed application scenarios of the exemplary embodiments of the present disclosure will be further illustrated below.

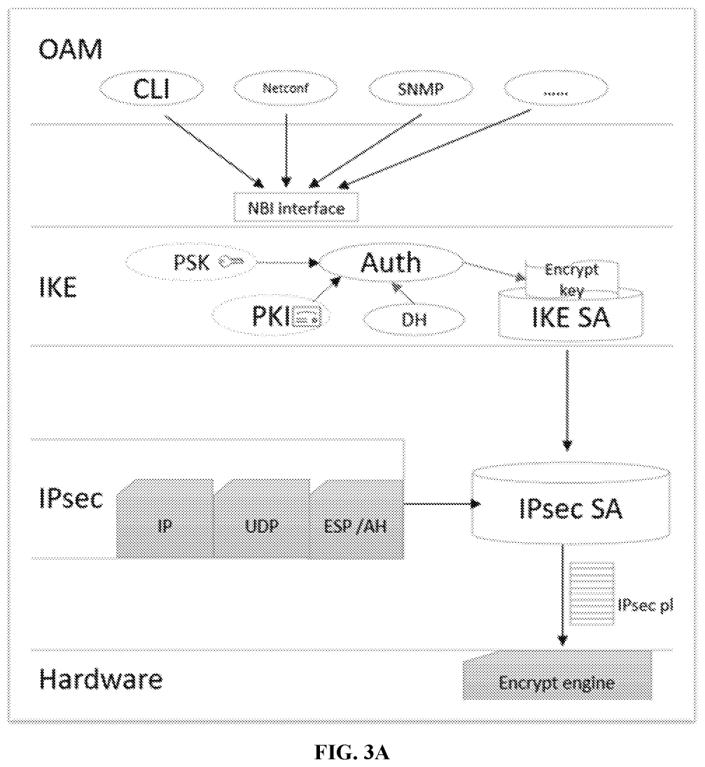

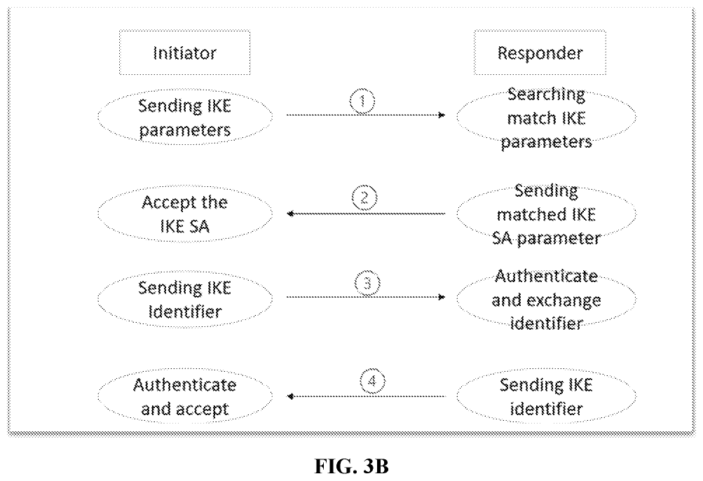

FIG. 3A is a general IPsec architecture diagram.

As shown in FIG. 3A, the IPsec architecture includes OAM layer, IKE protocol and IPsec data plane and hardware layer.

OAM includes the CLI (command line), Netconf (network configuration protocol) and SNMP (Simple Network Management Protocol) related management protocol, the functions of this layer are mainly focused on the IPsec configuration and state management. These functions of this layer may be connected to Northbound interface (NBI interface).

IKE is most important IPsec protocol, which is focused on control plane management. An authentication function may use pre-shared key (PSK), Public Key Infrastructure (PKI), Diffie-Hellman key exchange (DH), to generate and exchange an encrypt key, via IKE Security Association (SA).

IPsec layer, including IP (internet protocol), UDP (User Datagram Protocol), ESP/AH (Encapsulating Security Payload/Authentication Header) mainly processes on the traffic or called data plane management. Via IPsec SA, IPsec packet will be generated.

Hardware, including some NPUs or encryption chips as the encrypt engine, run at the physical layer to speed up IPsec data encryption progress.

IKEv2 is defined in RFC 4306 and updated by RFC 5996 (chapter 1.2), see https://datatracker.ietf.org/doc/html/rfc5996 #section-1.2.

Using IKEv2 to negotiate an SA is much simpler than using IKEv1, thus is much more efficient. To establish a pair of IPsec SA, IKEv1 needs to go through two phases: Main mode and Fast mode, or Aggressive mode and fast mode. The former requires at least nine messages to be exchanged, and the latter requires at least six messages to be exchanged. However, in IKEv2, a pair of IPsec SA can be established using two exchanges with a total of four messages. If more than one pair of IPsec SA needs to be established, you only need to add one child SA exchange for each pair of IPsec SA, that is two messages. In IKEv2, the main mode and aggressive mode in IKEv1 is replaced with Initial Exchange, and the fast mode phase is replaced with CRATE_CHILD_SA.

FIG. 3B is an exemplary diagram showing a procedure of IKEv2.

As shown in FIG. 3B, via a message 1, an initiator may send IKE parameters to a responder. The responder may search match IKE parameters, and then send matched IKE SA parameter via message 2.

The initiator may accept the IKE SA. Then, the initiator sends IKE identifier via message 3. The responder authenticates and exchange identifier.

The responder may send IKE identifier to the initiator via message 4. Then, the initiator authenticates and accepts IKE identifier from the responder.

The first pair of messages (1+2) (IKE_SA_INIT) negotiate cryptographic algorithms, exchange nonces, and do a Diffie-Hellman exchange [DH]. The second pair of messages (3+4) (IKE_AUTH) authenticate the previous messages, exchange identities and certificates, and establish the first Child SA.

Pre-shared Key or RSA signature (PKI based) authentication is used in the second exchange (3+4) messages.

Embodiments of the present disclosure may propose a new authentication plugin in the IKE protocol.

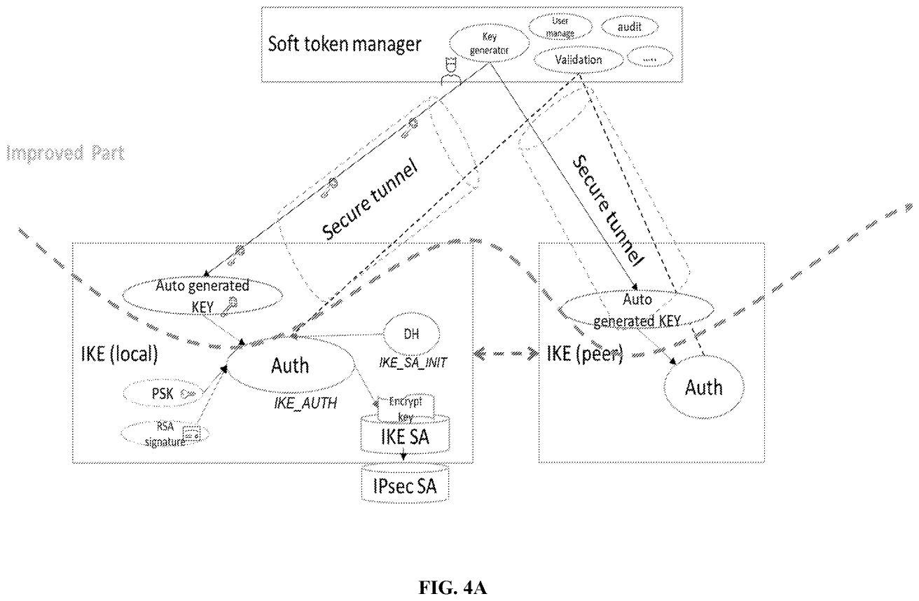

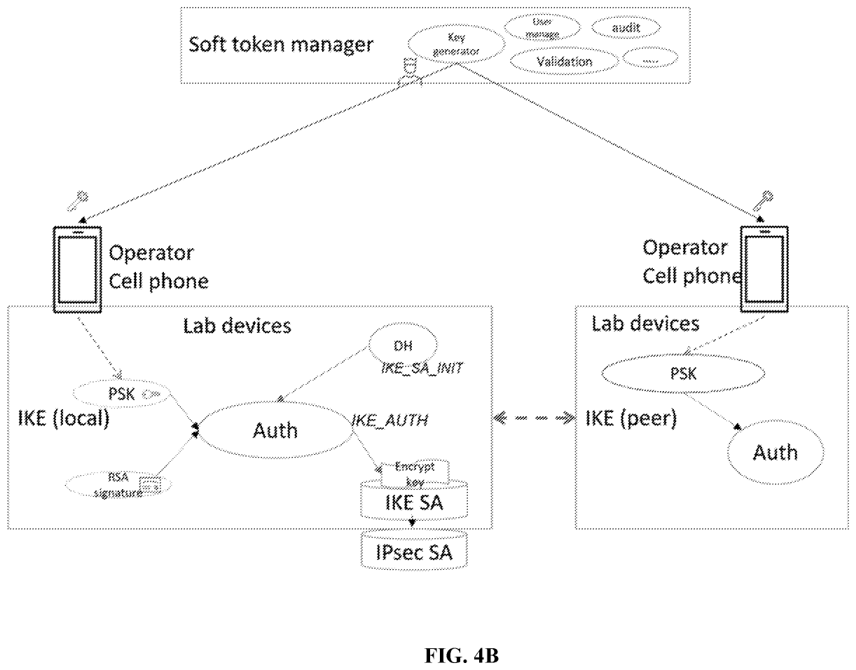

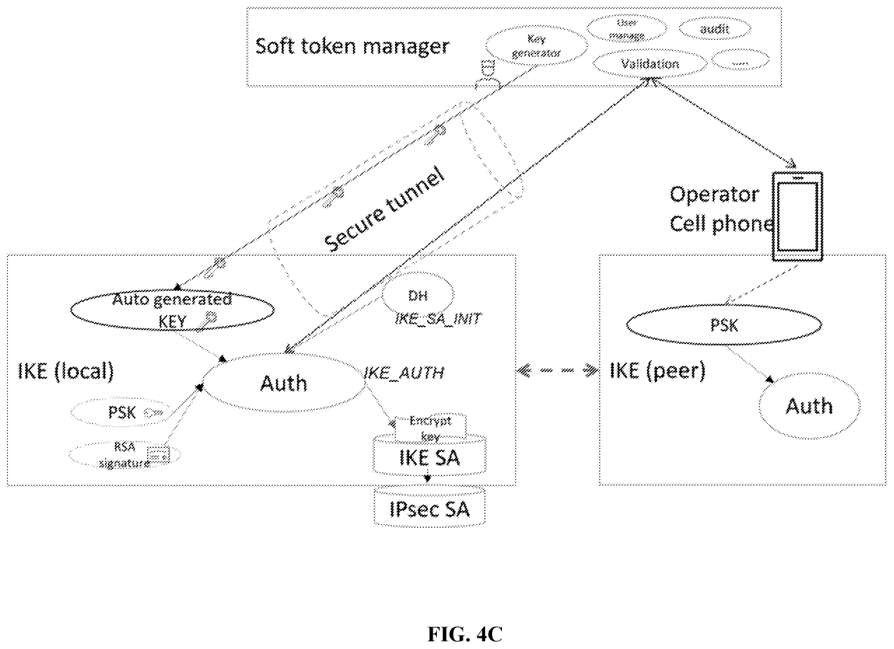

FIG. 4A is a first exemplary diagram showing an embedded plugin in IKE protocol to automatically generate the IKE soft token keys to be used in IKE authentication exchange, according to embodiments of the present disclosure.

A centralized Soft Token Manager is deployed in a network node.

IKE local and peer devices should establish the security tunnel between a communication device (the IPsec device) and a network node (Soft Token Manager). This can take advantage of the current mobile network deployment, such as installing a SIM card to access the Internet, or private link access if possible. Since it is a lightweight plug-in, additional deployment is not expected to take much effort.

The improved procedure may include following.

In a procedure 1, IKE endpoint dial-in the network and connected to the soft-token manager. Soft Token Manager will authorize the dial-in number (could be phone/serial number) or the username/password to grant the permission to generate the soft tokens, that could be numeric password to be used be IKE.

In a procedure 2, once IKE fetches the auto-generated key, it can be used in the IKE authentication exchange messages. This key info could be encrypted and not visible to operator of the communication device, so as to make it secure.

In a procedure 3, IKE peers (for example, a first communication device and a second communication device) will authenticate each other and then establish the IKE and IPsec SA.

In a procedure 4, once the tunnel is required to re-authentication (maybe caused by manual configuration, or network failure), then it will trigger the validation with soft token Manager. The soft token manager will check whether the key state is activated or not. If expired, then the soft token manager will generate the IKE keys again.

FIG. 4B is a second exemplary diagram showing an embedded plugin in IKE protocol to automatically generate the IKE soft token keys to be used in IKE authentication exchange, according to embodiments of the present disclosure.

As shown in FIG. 4B, another alternative solution is more flexible with help of operators' mobile devices (UE, maybe a cell phone). This is helpful for the lab devices, since it is highly possible that the SIM card is not easy to be integrate with devices on racks. The alternative solution is using a UE device bound to devices' hardware identifier (serial number) and generate the dynamic key according to the hardware identifiers.

For example, the UE devices could be: mobile phones, mobile tablet (pad), intelligent terminals, multimedia devices, streaming media devices and so on.

The Soft token Manager could be: X86 server, Network Management System and some equivalent server.

The Lab devices could be: Router, L3 Switch, Firewall, Security Gateway and so on.

The improved procedure may include following.

In a procedure 1, operators/users use a UE device to connect with the soft-token manager.

Soft Token Manager will authorize the dial-in number (could be phone number) or the username/password to grant the permission to generate the soft tokens, meanwhile the UE need to be bound to IPsec devices hardware identifier, and Soft Token Manager could generate the key and display it in UE's windows. Then, operators could use the key as quick pre-shared key as IKE authentication materials.

The operators may input the key in the lab devices manually. Alternatively, the UE device may transmit the key to the lab devices automatically when there is a connection (such as blue teeth, WIFI, etc.) between the UE device and the lab device. In such situation, the key will be kept as unknown the operator.

In a procedure 2, once IKE fetches the auto-generated key, it can be used in the IKE authentication exchange messages.

In a procedure 3, IKE peers will authenticate each other and then establish the IKE and IPsec SA.

In a procedure 4, once the tunnel is required to re-authentication (maybe caused by manual configuration, or network failure), then operator could just use the UE to generate the key again. The key should be updated accordingly to keep its security.

FIG. 4C is a third exemplary diagram showing an embedded plugin in IKE protocol to automatically generate the IKE soft token keys to be used in IKE authentication exchange, according to embodiments of the present disclosure.

As shown in FIG. 4C, a mixed network scenario is always existing. In this case, the solution shows more advantage, because this could be a flexible and friendly way for operator. He can choose the different deploy method according to variant access schema. Soft token generation is following same way of above.

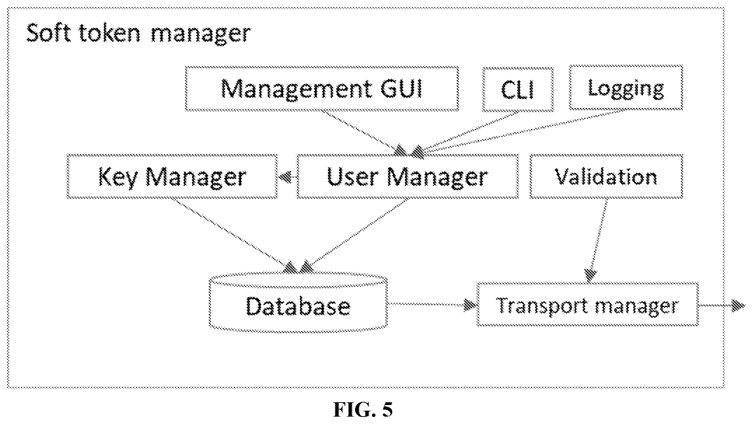

FIG. 5 is a diagram showing an exemplary system architecture of a Soft Token Manager.

In management layer, it could have the GUI/CLI (Graphical User Interface/Command Line Interface) interface to login on the system and manage the user and soft tokens. The logging module could record some logs for debug purpose.

In function layer, it has the essential functions of User manager/token (key) manager and validation plugin (optional).

In the transport layer (hardware layer), it should have a transport session for offering TCP/UDP transport protocols. And the database should be applied for user/key management.

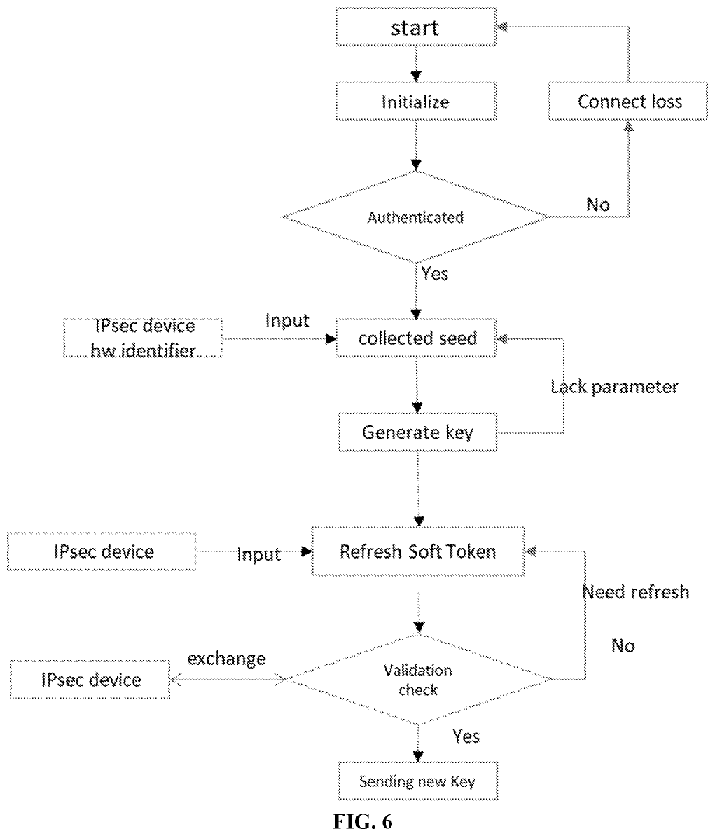

FIG. 6 is a flow chart showing a workflow for the key generation procedure.

As shown in FIG. 6, the procedure for the key generation may include following main steps.

The soft token manager starts the procedure for the key generation.

The soft token manager initializes a state to load the user/key datastore and open the port to listening the exchange message.

The soft token manager checks whether a request is authenticated. Once the soft token manager receives the login message, it will authenticate the account by username and password.

If yes, namely authenticated, the soft token manager goes forward to collect seed. If no, namely not authenticated, there is a connect loss and the soft token manager returns to start the whole procedure.

The soft token manager collects the IKE devices seed as the key generation materials. The seed could be the hardware serial number or IKE ID (from IPsec device hardware identifier inputted to the soft token manager), which may be a string type. The seed may include both local and remote peer information.

Examples of seed for the key calculation may include: username, local hardware/IKE identifier and remote hardware/IKE identifier, timestamp (UTC time), etc.

The soft token manager will generate the key and send the key to terminal IPsec device (UE, lab devices, etc.). If there is a lack of parameter, the soft token manager will turn back to collect further seed.

When there is a customer (an IPsec device) need to refresh the key, then it will trigger a recalculation on the key, namely refresh soft token.

The soft token manager may (optionally) make validation check of the key for the IPsec device, it could support the validation between IKE and soft token manager. It's for real-time synchronizing/exchanging and validating of the key status.

If the key refresh is pass and optional validation is good, it will send the new key to terminal. If the validation is not good, the soft token manager will return to refresh soft token.

Further, in embodiments of the present disclosure, a security tunnel between the IKE and Soft Token Manager should have feasible solution in varies network scenarios. A lightweight tunneling protocol is usually recommended. Generally it can be selected from tunnel protocols, like L2TP/PPTP/SSL (Layer 2 Tunneling Protocol/Point-to-Point Tunneling Protocol/Secure Socket Layer), IPsec as well.

Take IPsec as example. It is recommended to use VC (Vendor Credential) as node authentication material. Soft token manager should install the VC CA certificate. If possible, the semi-authentication is selected to lightweight the exchange of authentication. Security tunnel is only used between IKE and Soft Token Manager. Tunnel keep alive message is used.

The establishment step may include following.

In a step 1, the device UE needs to have complete Vendor Credentials which are burned in before out of factory.

In a step 2, IKE protocol stack starts initializing the establishment with Soft Token Manager with IKE_SA_INIT exchange message. Soft Token Manager will reply to the message and select the matched IKE proposals.

In a step 3, IKE devices send out the IKE_AUTH message with VC in the payload, and Soft Token Manager will authenticate the user credential. When the authentication successes, then it replies to the message with its own certificate. Semi-authentication successes if Soft Token Manager passes the one-way authentication. Optionally, the IKE devices can authenticate the Soft Token Manager as well. In that case, only after the bidirectional authentication is done the tunnel is established.

In a step 4, keep-alive message is sent between IKE devices and Soft Token Manager. To keep the connection alive, the connection was broken only when manually removed. Other tunnel protocol could be alternative solution.

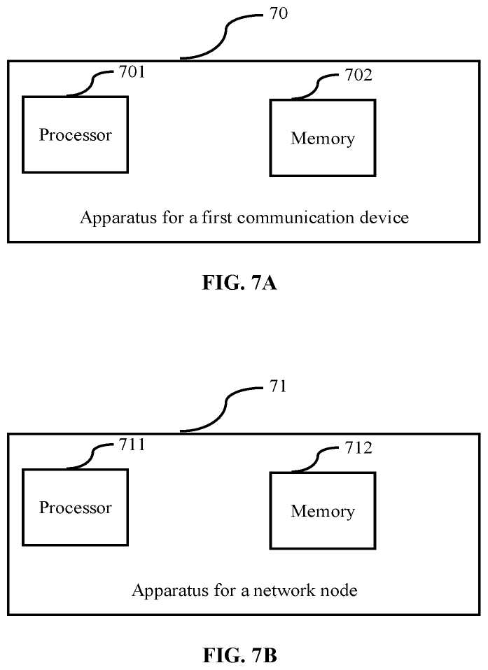

FIG. 7A is a block diagram showing an exemplary apparatus for a first communication device, which is suitable for performing the method according to embodiments of the disclosure.

As shown in FIG. 7A, the apparatus 70 for the first communication device comprises: a processor 701, a memory 702. The memory 702 contains instructions executable by the processor 701. The apparatus 70 for the first communication device is operative for: connecting to a network node; receiving a token from the network node; and using the token for internet key exchange, IKE.

In embodiments of the present disclosure, the apparatus 70 is further operative to perform the method according to any of the above embodiments, such as these shown in FIG. 1A, 1B, etc.

FIG. 7B is a block diagram showing an exemplary apparatus for a network node, which is suitable for performing the method according to embodiments of the disclosure.

As shown in FIG. 7B, the apparatus 71 for the network node comprises: a processor 711, a memory 712. The memory 712 contains instructions executable by the processor 711. The apparatus 71 for the network node is operative for: connecting to a first communication device; and transmitting a token to the first communication device. The first communication device uses the token for internet key exchange, IKE.

In embodiments of the present disclosure, the apparatus 71 is further operative to perform the method according to any of the above embodiments, such as these shown in FIG. 2A, 2B, etc.

The processors 701, 711 may be any kind of processing component, such as one or more microprocessor or microcontrollers, as well as other digital hardware, which may include digital signal processors (DSPs), special-purpose digital logic, and the like. The memories 702, 712 may be any kind of storage component, such as read-only memory (ROM), random-access memory, cache memory, flash memory devices, optical storage devices, etc.

Particularly, the communication device may be a UE referring to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IOT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The processors 701, 711 may be configured to process instructions and data and may be configured to implement any sequential state machine operative to execute instructions stored as machine-readable computer programs in the memory. The processors 701, 711 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processors 701, 711 may include multiple central processing units (CPUs).

The memories 702, 712 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memories 702, 712 include one or more application programs, such as an operating system, web browser application, a widget, gadget engine, or other application, and corresponding data. The memories 702, 712 may store, for use by the UE, any of a variety of various operating systems or combinations of operating systems.

The memories 702, 712 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memories 702, 712, which may be or comprise a device-readable storage medium.

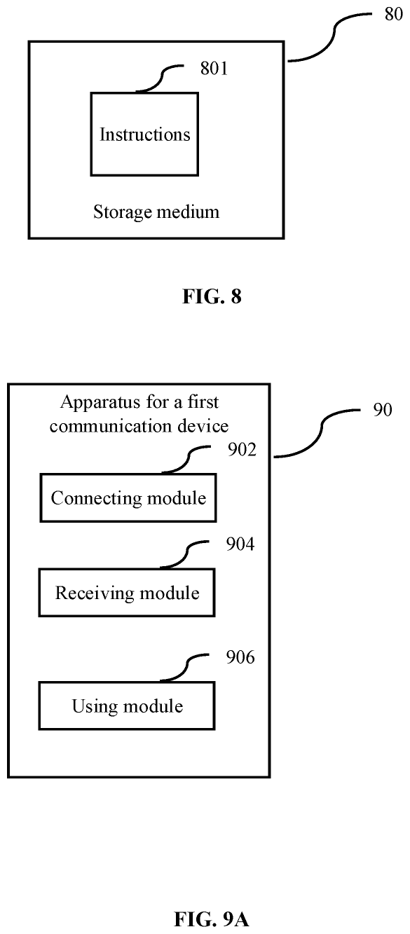

FIG. 8 is a block diagram showing an apparatus/computer readable storage medium, according to embodiments of the present disclosure.

As shown in FIG. 8, the computer-readable storage medium 80, or any other kind of product, storing instructions 801 which when executed by at least one processor, cause the at least one processor to perform the method according to any one of the above embodiments, such as these shown in FIG. 1A, 1B, 2A, 2B, etc.

In addition, the present disclosure may also provide a carrier containing the computer program as mentioned above, the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

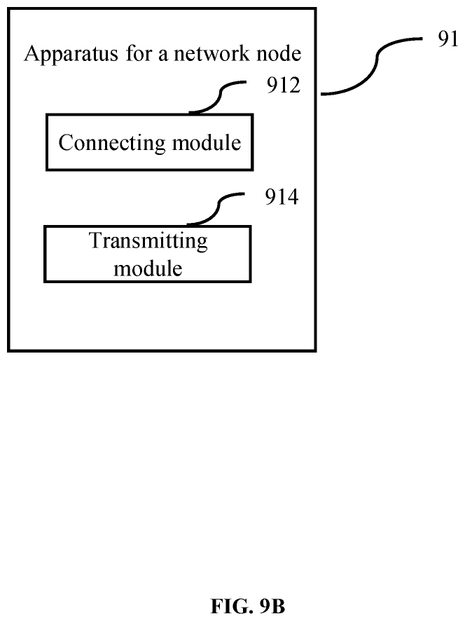

FIG. 9A is a block diagram showing modules for a first communication device, which are suitable for performing the method according to embodiments of the disclosure.

As shown in FIG. 9A, the apparatus 90 for the first communication device may comprise: a connecting module 902, configured for connecting to a network node; a receiving module 904, configured for receiving a token from the network node; and a using module 906, configured for using the token for internet key exchange, IKE.

In embodiments of the present disclosure, the apparatus 90 is further operative to perform the method according to any of the above embodiments, such as these shown in FIG. 1A, 1B, etc.

FIG. 9B is a block diagram showing modules for a network node, which are suitable for performing the method according to embodiments of the disclosure.

As shown in FIG. 9B, the apparatus 91 for the network node may comprise: a connecting module 912, configured for connecting to a first communication device; and a transmitting module 914, configured for transmitting a token to the first communication device. The first communication device uses the token for internet key exchange, IKE.

In embodiments of the present disclosure, the apparatus 91 is further operative to perform the method according to any of the above embodiments, such as these shown in FIG. 2A, 2B, etc.

These modules may include, for example, electrical and/or electronic circuitry, devices, units, processors, memories, logic solid state and/or discrete devices, computer programs or instructions for carrying out respective tasks, procedures, computations, outputs, and/or displaying functions, and so on, as such as those that are described herein.

With these modules, the apparatus may not need a fixed processor or memory, any kind of computing resource and storage resource may be arranged from at least one network node/device/entity/apparatus relating to the communication system. The virtualization technology and network computing technology (e.g., cloud computing) may be further introduced, so as to improve the usage efficiency of the network resources and the flexibility of the network.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules/units), or combinations thereof. For a firmware or software, implementation may be made through modules (e.g., procedures, functions, and so on) that perform the functions described herein.

Particularly, these function modules may be implemented either as a network element on a dedicated hardware, as a software instance running on a dedicated hardware, or as a virtualized function instantiated on an appropriate platform, e.g., on a cloud infrastructure.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

The followings are the references which are incorporated herein in their entirety:
RFC2406: IP Encapsulating Security Payload (ESP), November 1998
RFC6311: Protocol Support for High Availability of IKEv2/IPsec, July 2011
RFC7296: Internet Key Exchange Protocol Version 2 (IKEv2), October 2014
RFC4306: Internet Key Exchange (IKEv2) Protocol, December 2005
RFC5996: Internet Key Exchange Protocol Version 2 (IKEv2), September 2010

| ABBREVIATION | EXPLANATION |
|---|---|
| IKE | Internet Key Exchange |
| IPsec | IP Security |
| SA | Security Association |
| ESP | Encapsulating Security Payload |
| AH | Authentication Header |
| RFC | Request for Comments |
| PKI | Public Key Infrastructure. |

1-27. (canceled)

28. A method performed by a first communication device, comprising:
connecting to a network node;
receiving a token from the network node; and
using the token for internet key exchange (IKE).

29. The method of claim 28,
wherein the token is used as a pre-shared key (PSK) for the IKE; or
wherein the PSK is calculated based on the token.

30. The method of claim 28, wherein the token comprises numeric password.

31. The method of claim 28, wherein the token is encrypted.

32. The method of claim 28, wherein the token is received by the first communication device via a security tunnel.

33. The method of claim 28, wherein the token is configured with an expiration period.

34. The method of claim 28, wherein the token is generated by the network node, based at least on an identifier of the first communication device.

35. The method of claim 34, wherein the identifier comprises a dial-in number, or a user name with password.

36. The method of claim 28, wherein the IKE is between the first communication device and a second communication device.

37. The method of claim 28, further comprising:
transmitting the token to a third communication device;
wherein the IKE is between the third communication device and a second communication device.

38. The method of claim 28,
wherein the first communication device comprises a user equipment (UE); and/or
wherein the network node comprises a soft token manager.

39. A method performed by a network node, comprising:
connecting to a first communication device; and
transmitting a token to the first communication device;
wherein the first communication device uses the token for internet key exchange (IKE).

40. The method of claim 39,
wherein the token is used as a pre-shared key (PSK) for the IKE; or
wherein the PSK is calculated based on the token.

41. The method of claim 39, wherein the token comprises numeric password.

42. The method of claim 39, wherein the token is encrypted.

43. The method of claim 39, wherein the token is transmitted by the network node via a security tunnel.

44. The method of claim 39, wherein the token is configured with an expiration period.

45. The method of claim 39, further comprising: generating the token, based at least on an identifier of the first communication device.

46. The method of claim 45, wherein the identifier comprises a dial-in number, or a user name with password.

47. An apparatus for a first communication device, comprising:
a processor; and
a memory, the memory containing instructions executable by the processor;
wherein the apparatus for the first communication device is operative for:
connecting to a network node;
receiving a token from the network node; and
using the token for internet key exchange (IKE).
